(19) United States
(12) Patent Application Publication
(10) Pub. No.: US 2024/0129804 A1
(43) Pub. Date: Apr. 18, 2024

(54) APPARATUS, SYSTEM, AND METHOD OF QUALITY OF SERVICE (QOS) NETWORK SLICING OVER WIRELESS LOCAL AREA NETWORK (WLAN)

(71) Applicant: Intel Corporation, Santa Clara, CA (US)

(72) Inventors: Roya Doostnejad, Los Altos, CA (US); Ehud Reshef, Kiryat Tivon (IL); Laurent Cariou, Milizac (FR)

(73) Assignee: Intel Corporation, Santa Clara, CA (US)

(21) Appl. No.: 18/399,260

(22) Filed: Dec. 28, 2023

(51) Int. Cl. H04W 28/24; H04W 28/02; H04W 48/18

(52) U.S. Cl. CPC H04W 28/24; H04W 28/0268; H04W 48/18; H04W 84/12

(57) ABSTRACT

For example, an Access Point (AP) may be configured to process network slicing information including slice identification information and Service Level Agreement (SLA) information, wherein the slice identification information is to identify one or more Quality of Service (QoS) network slices. For example, the AP may be configured to determine a configuration of one or more radio resource allocations to be assigned to the one or more QoS network slices, and to transmit a network slicing advertisement including network slicing assignment information to indicate an assignment of the one or more radio resource allocations to the one or more QoS network slices.

### BACKGROUND

Devices in a wireless communication system may be configured to communicate according to communication protocols, which may be configured to support Quality of Service (QoS) requirements.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of components and operations of a Quality of Service (QoS) network slicing mechanism, which may be implemented in accordance with some demonstrative aspects.

FIG. 3 is a schematic flow-chart illustration of a method of QoS network slicing over Wireless Local Area Network (WLAN), in accordance with some demonstrative aspects.

FIG. 4 is a schematic flow-chart illustration of a method of QoS network slicing over WLAN, in accordance with some demonstrative aspects.

FIG. 5 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology— Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D4.0 Draft Standard for Information technology— Telecommunications and information exchange between systems Local and metropolitan area networks— Specific requirements; Part 11: Wireless LAN Medium Access Control (MAC) and Physical Layer (PHY) Specifications; Amendment 8: Enhancements for extremely high throughput (EHT), July 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

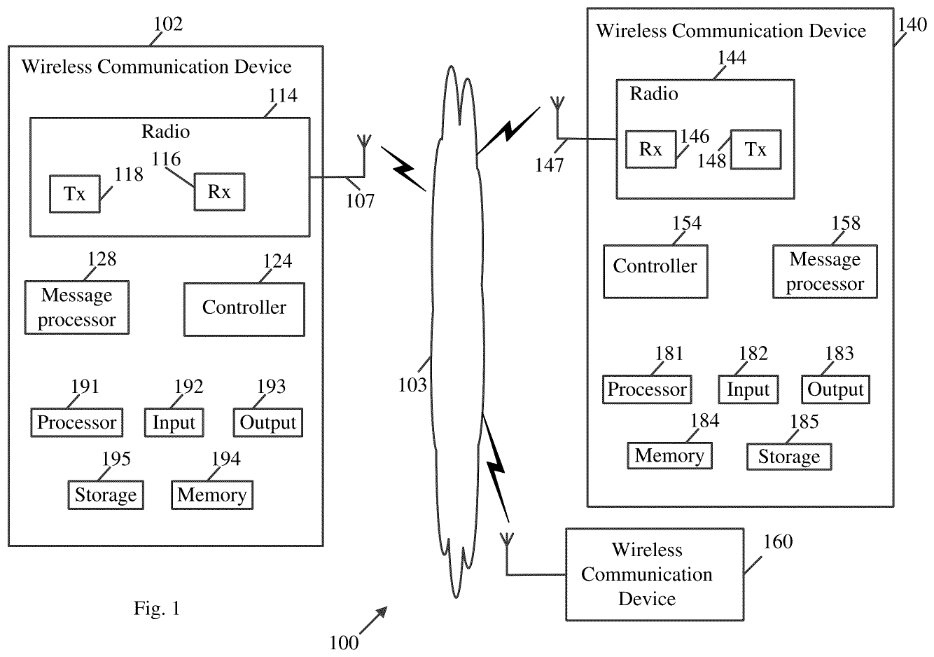

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may be configured to implement one or more operations and/or functionalities of a Quality of Service (QoS) network slicing mechanism (WLAN-based QoS network slicing mechanism”), which may be configured to support QoS network slicing over WLAN, e.g., as described below.

In some demonstrative aspects, the WLAN-based QoS network slicing mechanism may be configured to provide a technical solution to support improved, e.g., optimized, network operations, for example, in enterprise deployments and/or any other implementations, use cases, and/or deployments, e.g., as described below.

In some demonstrative aspects, the WLAN-based QoS network slicing mechanism may be configured to provide a technical solution to simultaneously support multiple use cases with different QoS requirements including, for example, latency, throughput, and/or reliability, e.g., as described below.

In some demonstrative aspects, the WLAN-based QoS network slicing mechanism may be configured to provide a technical solution to support multiple logical networks, which may be tailored, for example, to different user requirements, e.g., over a common infrastructure, as described below.

In some demonstrative aspects, the WLAN-based QoS network slicing mechanism may be configured to provide a technical solution to support management and/or optimization of network operations to support multiple use cases over WLAN, e.g., as described below.

In one example, in some environments, for example, a healthcare environment, a WLAN-based QoS network slicing mechanism may be configured to utilize one or more WLAN-based QoS network slices to support safe operation for one or more types of applications, e.g., core of sensitive health applications, while one or more other WLAN-based QoS network slices may be configured to support other users, e.g., hospital visitors, which may still be allowed to play games or watch videos.

In another example, in some deployments, for example, in a factory, a QoS network slicing mechanism may be configured to utilize one or more WLAN-based QoS network slices to support the operation on production lines, e.g., which should be protected from expensive or dangerous disruptions and/or which may require support of new virtual/augmented reality applications, while one or more other WLAN-based QoS network slices may be configured to support other uses, e.g., still allowing employees on breaks to access their videos.

In some demonstrative aspects, device 102, device 140, and/or device 160 may be configured to implement one or more operations and/or functionalities of a WLAN-based QoS network slicing mechanism, which may be configured, for example, to provide a technical solution to support a flexible framework implementation, e.g., as described below.

In some demonstrative aspects, device 102, device 140, and/or device 160 may be configured to implement one or more operations and/or functionalities of a WLAN-based QoS network slicing mechanism, which may be configured, for example, to provide a technical solution to support QoS network slicing, for example, by allocating radio resources to a plurality of different QoS network slices, e.g., as described below.

In some demonstrative aspects, the allocation of the radio resources to the plurality of different QoS network slices may be configured, for example, to provide a technical solution to assure a plurality of different service level agreements, e.g., as described below.

In some demonstrative aspects, the WLAN-based QoS network slicing mechanism may be configured to support a device, e.g., a non-AP device, to be able to access one or more QoS network slices, e.g., any suitable QoS network slice, for example, based on application requirements, e.g., as described below.

In some demonstrative aspects, the WLAN-based QoS network slicing mechanism may be configured to address one or more technical issues, which may be associated with implementing QoS network slicing over WLAN, e.g., as described below.

For example, a QoS network slicing technique, e.g., which may be implemented by a 5G network, may implement network slicing, for example, by orthogonal resource allocation among multiple services, e.g., with different latency and throughput requirements.

For example, it may be inefficient, e.g., in terms of resource utilization, to configure a WLAN QoS network slicing based only on time-scheduled resource allocations. For example, such an implementation may not be sufficient to support applications with one or more constraints, e.g., latency and/or reliability constraints.

For example, a WLAN QoS network slicing may be configured based on leveraging of a multi-tenant architecture on a single AP, for example, by using multiple different Service Set Identifiers (SSIDs). For example, different channels with different characteristics, e.g., bandwidth and/or center frequency, may be dedicated to different slices. For example, the channels may be identified with distinct SSIDs, and treated as separate networks. However, QoS network slicing according to this SSID-based approach may limit devices to one specific slice, e.g., through Carrier Sense Multiple Access (CSMA) techniques. For example, the QoS network slicing according to the SSID-based approach may not have flexibility to use other resources in other slices, to easily move across slices, and/or to support devices, for example, to communicate directly, and/or to access resources on different SSIDs.

In some demonstrative aspects, device 102, device 140, and/or device 160 may be configured to implement one or more operations and/or functionalities of a WLAN-based QoS network slicing mechanism, which may be configured, for example, to provide a technical solution to support flexible slicing in WLAN, e.g., Wi-Fi, for example, by allocating radio resources to one or more QoS network slices, e.g., as described below.

In some demonstrative aspects, the WLAN-based QoS network slicing mechanism may be configured, for example, to allocate radio resources to one or more QoS network slices, e.g., to each slice, for example, to assure Service Level Agreements (SLA) for different applications, which may be served simultaneously, e.g., as described below.

In one example, an SLA may be defined to assure that a delay for communication of traffic is not to exceed a maximal delay, e.g., for low latency use cases and/or applications.

In one example, an SLA may be defined to assure a minimum data rate for communication of traffic, e.g., for high throughput use cases and/or applications.

In one example, an SLA may be defined to assure a maximal packet data rate (PDR), e.g., for high reliability use cases and/or applications.

In some demonstrative aspects, the WLAN-based QoS network slicing mechanism may be configured, for example, to assign to a QoS network slice one or more shared radio resources, which may be shared with one or more other QoS network slices, e.g., as described below.

In some demonstrative aspects, the WLAN-based QoS network slicing mechanism may be configured, for example, to assign to a QoS network slice one or more dedicated radio resources, which may be dedicated to the QoS network slice, e.g., as described below.

In some demonstrative aspects, the WLAN-based QoS network slicing mechanism may be configured, for example, to assign to a QoS network slice one or more prioritized radio resources, which may be configured to prioritize traffic of the QoS network slice, for example, over traffic of other QoS network slices, e.g., as described below.

In some demonstrative aspects, the WLAN-based QoS network slicing mechanism may be configured, for example, to utilize one or more WLAN techniques, e.g., OFDMA and/or Multi-Link Operation (MLO), for example, to facilitate association and/or orchestration across different QoS network slices, e.g., as described below.

In some demonstrative aspects, the WLAN-based QoS network slicing mechanism may be configured, for example, to provide a framework to facilitate slice-aware AP reselection and/or handover, e.g., as described below.

In some demonstrative aspects, the WLAN-based QoS network slicing mechanism may be configured to provide a technical solution, which may be extended to multi-spectrum, e.g., as described below.

In some demonstrative aspects, the WLAN-based QoS network slicing mechanism may be configured, for example, to provide a framework, which may be implemented by WLANs, e.g., WiFi networks, for example, to support multiple traffic types while satisfying their various QoS requirements, e.g., as described below.

In some demonstrative aspects, the WLAN-based QoS network slicing mechanism may be configured, for example, to provide a technical solution to support interworking between 5G networks and WLANs, for example, to provide next generation access technologies, e.g., for enterprises.

In some demonstrative aspects, the WLAN-based QoS network slicing mechanism may be configured, for example, to provide a technical solution to support network slicing with guaranteed QoS, for example, over WLANs, e.g., as described below.

In some demonstrative aspects, the ability to perform network slicing with guaranteed QoS over WLANs may be implemented to provide a technical solution to support employment of WLANs, for example, as a standalone connectivity in enterprises, and/or as an integrated connectivity in a 5G ecosystem.

In some demonstrative aspects, the WLAN-based QoS network slicing mechanism may be configured, for example, to provide a technical solution to support a WLAN device, e.g., a non-AP STA, to communicate with multiple QoS network slices, to perform slice-aware AP selection, and/or to perform slice-aware AP roaming, e.g., as described below.

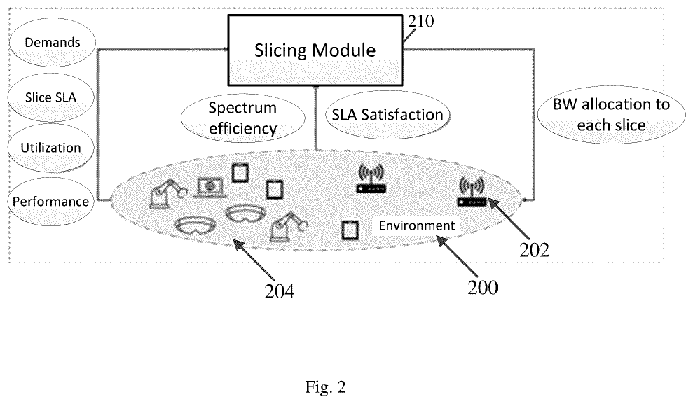

Reference is now made to FIG. 2, which schematically illustrates components and operations of a QoS network slicing mechanism, which may be implemented in accordance with some demonstrative aspects. For example, FIG. 2 may illustrate high level components and process, which may participate in QoS network slicing.

For example, as shown in FIG. 2, one or more wireless communication networks may be deployed in an environment 200, e.g., an enterprise environment, and/or any other environment.

For example, as shown in FIG. 2, the environment 200 may include one or more APs 202, which may be configured to control communication of one or more client devices 204, e.g., non-AP STAs, in one or more wireless communication networks.

In one example, an AP 202 may include one or more elements of wireless communication device 102 (FIG. 1), and/or may perform one or more operations and/or functionalities of wireless communication device 102 (FIG. 1).

In one example, a client device 204 may include one or more elements of wireless communication device 140 (FIG. 1), and/or may perform one or more operations and/or functionalities of wireless communication device 140 (FIG. 1).

In some demonstrative aspects, as shown in FIG. 2, a slicing module (also referred to as “network slicing manager”) 210, which may be configured to define and/or manage one or more QoS network slices, for example, based on requirements of one or more Service Level Agreements (SLAs).

In some demonstrative aspects, one or more elements and/or functionalities of slicing module 210 may be implemented by a network device, e.g., a network management device.

In some demonstrative aspects, one or more elements and/or functionalities of slicing module 210 may be implemented by an AP 202.

In some demonstrative aspects, elements and/or functionalities of slicing module 210 may be distributed between a network device and an AP 202.

In some demonstrative aspects, as shown in FIG. 2, slicing module 210 may be configured to determine and/or to dynamically adjust bandwidth allocations for one or more QOS network slices, for example, based on one or more parameters and/or criteria.

In some demonstrative aspects, as shown in FIG. 2, slicing module 210 may be configured to determine and/or to dynamically adjust bandwidth allocations for one or more QOS network slices, for example, based on performance information relating to one or more performance parameters corresponding to the one or more QOS network slices.

In some demonstrative aspects, as shown in FIG. 2, slicing module 210 may be configured to determine and/or to dynamically adjust bandwidth allocations for one or more QOS network slices, for example, based on utilization information relating to one or more utilization parameters corresponding to the one or more QOS network slices.

In some demonstrative aspects, as shown in FIG. 2, slicing module 210 may be configured to determine and/or to dynamically adjust bandwidth allocations for one or more QOS network slices, for example, based on SLA information relating to one or more slice SLAs corresponding to the one or more QOS network slices.

In some demonstrative aspects, as shown in FIG. 2, slicing module 210 may be configured to determine and/or to dynamically adjust bandwidth allocations for one or more QOS network slices, for example, based on demand information relating to one or more demand parameters corresponding to the one or more QOS network slices.

In some demonstrative aspects, as shown in FIG. 2, slicing module 210 may be configured to determine and/or to dynamically adjust bandwidth allocations for one or more QOS network slices, for example, based on spectrum information corresponding to a spectrum efficiency of a wireless communication spectrum utilized by one or more WLANs.

some demonstrative aspects, as shown in FIG. 2, slicing module 210 may be configured to determine and/or to dynamically adjust bandwidth allocations for one or more QOS network slices, for example, based on any other additional or alternative information and/or criteria.

In some demonstrative aspects, an algorithm implementation to realize the slicing module 210 may be implementation specific.

In some demonstrative aspects, one or more algorithms, e.g., machine-learning algorithms, may be implemented to configure radio resources, for example, for intelligent slicing, e.g., to guarantee SLA.

Referring back to FIG. 1, in some demonstrative aspects, controller 124 may be configured to control, trigger, cause, and/or instruct an AP implemented by device 102 to process network slicing information including slice identification information and SLA information, e.g., as described below.

In some demonstrative aspects, the slice identification information may be configured to identify one or more QoS network slices, e.g., as described below.

In some demonstrative aspects, the SLA information may be configured to indicate one or more SLAs corresponding to the one or more QoS network slices, e.g., as described below.

In some demonstrative aspects, the AP implemented by device 102 may receive the network slicing information from a network slicing manager, e.g., from network slicing manager 210 (FIG. 2).

In some demonstrative aspects, controller 124 may be configured to control, trigger, cause, and/or instruct the AP implemented by device 102 to determine a configuration of one or more radio resource allocations to be assigned to the one or more QoS network slices, e.g., as described below.

In some demonstrative aspects, a radio resource allocation for a QoS network slice may be configured to include an allocation of WLAN resources of a Basic Service Set (BSS) of the AP, for example, based on QoS requirements of an SLA corresponding to the QoS network slice, e.g., as described below.

In some demonstrative aspects, controller 124 may be configured to control, trigger, cause, and/or instruct the AP implemented by device 102 to transmit a network slicing advertisement, e.g., as described below.

In some demonstrative aspects, the network slicing advertisement may be configured to include network slicing assignment information to indicate an assignment of the one or more radio resource allocations to the one or more QoS network slices, e.g., as described below.

In some demonstrative aspects, controller 124 may be configured to control, trigger, cause, and/or instruct the AP implemented by device 102 to transmit the network slicing advertisement in a beacon frame.

In some demonstrative aspects, controller 124 may be configured to control, trigger, cause, and/or instruct the AP implemented by device 102 to transmit the network slicing advertisement in a neighbor report element.

In other aspects, controller 124 may be configured to control, trigger, cause, and/or instruct the AP implemented by device 102 to transmit the network slicing advertisement in any other additional or alternative type of frame.

In some demonstrative aspects, controller 124 may be configured to control, trigger, cause, and/or instruct the AP implemented by device 102 to set the network slicing advertisement to include the slice identification information to identify the one or more QoS network slices.

In some demonstrative aspects, controller 124 may be configured to control, trigger, cause, and/or instruct the AP implemented by device 102 to set the network slicing advertisement to include a slice Identifier (ID) to identify a QoS network slice.

In some demonstrative aspects, controller 124 may be configured to control, trigger, cause, and/or instruct the AP implemented by device 102 to set the network slicing advertisement to include a slice type indicator to identify a QoS network slice.

In some demonstrative aspects, controller 124 may be configured to control, trigger, cause, and/or instruct the AP implemented by device 102 to set the network slicing advertisement to include any other additional or alternative information to identify and/or indicate a QoS network slice.

In some demonstrative aspects, controller 124 may be configured to control, trigger, cause, and/or instruct the AP implemented by device 102 to configure a radio resource allocation to be assigned to a QoS network slice, for example, based on a throughput requirement of an SLA corresponding to the QoS network slice.

In some demonstrative aspects, controller 124 may be configured to control, trigger, cause, and/or instruct the AP implemented by device 102 to configure a radio resource allocation to be assigned to a QoS network slice, for example, based on a latency requirement of an SLA corresponding to the QoS network slice.

In some demonstrative aspects, controller 124 may be configured to control, trigger, cause, and/or instruct the AP implemented by device 102 to configure a radio resource allocation to be assigned to a QoS network slice, for example, based on a reliability requirement of an SLA corresponding to the QoS network slice.

In some demonstrative aspects, controller 124 may be configured to control, trigger, cause, and/or instruct the AP implemented by device 102 to configure the radio resource allocation to be assigned to the QoS network slice based on any other additional or alternative information and/or criteria.

In some demonstrative aspects, controller 124 may be configured to control, trigger, cause, and/or instruct the AP implemented by device 102 to configure one or more QoS characteristics of the radio resource allocation for the QoS network slice, for example, based on a throughput requirement of the SLA corresponding to the QoS network slice.

In some demonstrative aspects, controller 124 may be configured to control, trigger, cause, and/or instruct the AP implemented by device 102 to configure one or more QoS characteristics of the radio resource allocation for the QoS network slice, for example, based on a latency requirement of the SLA corresponding to the QoS network slice.

In some demonstrative aspects, controller 124 may be configured to control, trigger, cause, and/or instruct the AP implemented by device 102 to configure one or more QoS characteristics of the radio resource allocation for the QoS network slice, for example, based on a reliability requirement of the SLA corresponding to the QoS network slice.

In some demonstrative aspects, controller 124 may be configured to control, trigger, cause, and/or instruct the AP implemented by device 102 to configure one or more QoS characteristics of the radio resource allocation for the QoS network slice based on any other requirement and/or criteria.

In some demonstrative aspects, controller 124 may be configured to control, trigger, cause, and/or instruct the AP implemented by device 102 to configure a radio resource allocation for a QoS network slice to guarantee QoS requirements of an SLA corresponding to the QoS network slice.

In some demonstrative aspects, controller 124 may be configured to control, trigger, cause, and/or instruct the AP implemented by device 102 to configure the one or more radio resource allocations to include, for example, a default radio resource allocation, which may be configured, for example, to communicate traffic not belonging to the one or more QoS network slices, e.g., as described below.

In some demonstrative aspects, controller 124 may be configured to control, trigger, cause, and/or instruct the AP implemented by device 102 to configure a plurality of WLAN resource allocations for a respective plurality of simultaneously operative QoS network slices.

In some demonstrative aspects, controller 124 may be configured to control, trigger, cause, and/or instruct the AP implemented by device 102 to configure a first radio resource allocation for a first QoS network slice, for example, based on first QoS requirements of a first SLA corresponding to the first QoS network slice.

In some demonstrative aspects, controller 124 may be configured to control, trigger, cause, and/or instruct the AP implemented by device 102 to configure a second radio resource allocation for a second QoS network slice, for example, based on second QoS requirements of a second SLA corresponding to the second QoS network slice.

In some demonstrative aspects, controller 124 may be configured to control, trigger, cause, and/or instruct the AP implemented by device 102 to configure the second radio resource allocation to be different from the first radio resource allocation, for example, based on a determination that the second QoS requirements of the second SLA are different from the first QoS requirements of the first SLA.

In some demonstrative aspects, controller 124 may be configured to control, trigger, cause, and/or instruct the AP implemented by device 102 to determine an updated assignment of the one or more radio resource allocations to the one or more QoS network slices, for example, based on a change in the one or more QoS network slices, e.g., as described below.

In some demonstrative aspects, controller 124 may be configured to control, trigger, cause, and/or instruct the AP implemented by device 102 to transmit an updated network slicing advertisement including updated network slicing assignment information to indicate the updated assignment of the one or more radio resource allocations to the one or more QoS network slices.

In some demonstrative aspects, the change in the one or more QoS network slices may include an addition of at least one additional QoS network slice to the one or more QoS network slices.

In some demonstrative aspects, the change in the one or more QoS network slices may include a deletion of at least one deleted QoS network slice from the one or more QoS network slices.

In some demonstrative aspects, the change in the one or more QoS network slices may include a change in at least one updated QoS network slice of the one or more QoS network slices, for example, based on a change in an SLA of the updated QoS network slice.

In some demonstrative aspects, controller 124 may be configured to control, trigger, cause, and/or instruct the AP implemented by device 102 to determine an updated assignment of the one or more radio resource allocations to the one or more QoS network slices, for example, based on a utilization level of the one or more QoS network slices.

In some demonstrative aspects, controller 124 may be configured to control, trigger, cause, and/or instruct the AP implemented by device 102 to determine an updated assignment of the one or more radio resource allocations to the one or more QoS network slices, for example, based on traffic demands to communicate traffic with one or more non-AP STAs over the one or more QoS network slices.

In other aspects, controller 124 may be configured to control, trigger, cause, and/or instruct the AP implemented by device 102 to determine an updated assignment of the one or more radio resource allocations to the one or more QoS network slices based on any other additional or alternative suitable information and/or criteria.

In some demonstrative aspects, controller 124 may be configured to control, trigger, cause, and/or instruct the AP implemented by device 102 to process a connection request from a non-AP STA in the BSS of the AP, e.g., as described below.

In some demonstrative aspects, the connection request may be configured to identify a request to connect the non-AP STA to a requested QoS network slice of the one or more QoS network slices advertised by the AP.

In some demonstrative aspects, controller 124 may be configured to control, trigger, cause, and/or instruct the AP implemented by device 102 to transmit to the non-AP STA a connection response, which may be configured to indicate whether or not the connection request is accepted, e.g., as described below.

In some demonstrative aspects, controller 124 may be configured to control, trigger, cause, and/or instruct the AP implemented by device 102 to process a QoS network slice request from a non-AP STA in the BSS of the AP, e.g., as described below.

In some demonstrative aspects, the QoS network slice request may be configured to identify an additional QoS network slice to be added to the one or more QoS network slices, e.g., per request by the non-AP STA.

In some demonstrative aspects, controller 124 may be configured to control, trigger, cause, and/or instruct the AP implemented by device 102 to select whether to accept or reject the QoS network slice request, e.g., as described below.

In some demonstrative aspects, controller 124 may be configured to control, trigger, cause, and/or instruct the AP implemented by device 102 to configure a radio resource allocation for the additional QoS network slice, e.g., based on QoS requirements of an SLA corresponding to the additional QoS network slice, for example, based on a determination that the QoS network slice request is to be accepted.

In some demonstrative aspects, controller 124 may be configured to control, trigger, cause, and/or instruct the AP implemented by device 102 to configure a pool of radio resources to be used by a QoS network slice, for example, when the radio resource allocation for the QoS network slice is not available.

In some demonstrative aspects, controller 124 may be configured to control, trigger, cause, and/or instruct the AP implemented by device 102 to configure a radio resource allocation for a QoS network slice to include one or more dedicated radio resources, which may be, for example, dedicated to communication of traffic of the QoS network slice.

In some demonstrative aspects, controller 124 may be configured to control, trigger, cause, and/or instruct the AP implemented by device 102 to configure a radio resource allocation for a QoS network slice to include one or more prioritized radio resources, for example, to prioritize communication of traffic of the QoS network slice.

In some demonstrative aspects, controller 124 may be configured to control, trigger, cause, and/or instruct the AP implemented by device 102 to configure a radio resource allocation for a QoS network slice to include one or more shared radio resources, which may be, for example, shared with one or more other QoS network slices.

In some demonstrative aspects, controller 124 may be configured to control, trigger, cause, and/or instruct the AP implemented by device 102 to configure one or more radio resource allocations for the one or more QoS network slices, for example, to include one or more OFDMA Resource Unit (RU) allocations, e.g., as described below.

In some demonstrative aspects, the one or more OFDMA RU allocations may include a first OFDMA RU allocation of one or more first RUs assigned to a first QoS network slice.

In some demonstrative aspects, the one or more OFDMA RU allocations may include a second OFDMA RU allocation of one or more second RUs assigned to a second QoS network slice.

In some demonstrative aspects, controller 124 may be configured to control, trigger, cause, and/or instruct the AP implemented by device 102 to configure one or more radio resource allocations for the one or more QoS network slices, for example, to include one or more link allocations according to a Multi-Link Operation (MLO) scheme, e.g., as described below.

In some demonstrative aspects, the one or more link allocations may include a first link allocation of a first link assigned to a first QoS network slice, and a second link allocation of a second link assigned to a second QoS network slice, e.g., as described below.

In some demonstrative aspects, the first link allocation may include, for example, a first link in a first wireless communication frequency band.

In some demonstrative aspects, the second link allocation may include, for example, a second link in a second wireless communication frequency band.

In some demonstrative aspects, the first and second link allocations may be, for example, in a same wireless communication frequency band.

In some demonstrative aspects, controller 124 may be configured to control, trigger, cause, and/or instruct the AP implemented by device 102 to configure a radio resource allocation for a QoS network slice to include, for example, a first link and a second link, e.g., as described below.

In some demonstrative aspects, traffic of the QoS network slice may be assigned for communication over the first link at a higher priority compared, for example, to traffic of one or more other QoS network slices.

In some demonstrative aspects, the traffic of the QoS network slice may be assigned for communication over the second link, for example, at a lower priority compared to traffic of another QoS network slice assigned to the second link.

In some demonstrative aspects, controller 154 may be configured to control, trigger, cause, and/or instruct a non-AP STA implemented by device 140 to process a network slicing advertisement from an AP, for example, to identify network slicing assignment information to indicate an assignment of one or more radio resource allocations to one or more QoS network slices, e.g., as described below.

In some demonstrative aspects, controller 154 may be configured to control, trigger, cause, and/or instruct a non-AP STA implemented by device 140 to identify a radio resource allocation for a QoS network slice including an allocation of WLAN resources of BSS of the AP.

In some demonstrative aspects, the network slicing advertisement may include slice identification information to identify the one or more QoS network slices.

In some demonstrative aspects, the slice identification information may include a slice ID to identify the QoS network slice.

In some demonstrative aspects, the slice identification information may include a slice type indicator to identify the QoS network slice.

In some demonstrative aspects, controller 154 may be configured to control, trigger, cause, and/or instruct a non-AP STA implemented by device 140 to identify the network slicing advertisement in a beacon frame from the AP.

In some demonstrative aspects, controller 154 may be configured to control, trigger, cause, and/or instruct a non-AP STA implemented by device 140 to identify the network slicing advertisement in a neighbor report element from the AP.

In some demonstrative aspects, controller 154 may be configured to control, trigger, cause, and/or instruct a non-AP STA implemented by device 140 to identify the network slicing advertisement transmitted by the AP implemented by device 102, e.g., as described above.

In some demonstrative aspects, controller 154 may be configured to control, trigger, cause, and/or instruct a non-AP STA implemented by device 140 to identify, for example, based on the network slicing assignment information, a particular radio resource allocation to be used by the non-AP STA to communicate traffic of a particular QoS network slice, e.g., as described below.

In some demonstrative aspects, controller 154 may be configured to control, trigger, cause, and/or instruct a non-AP STA implemented by device 140 to determine, for example, based on the network slicing assignment information, whether or not to associate with the AP from which the network slicing advertisement is received, e.g., as described below.

In some demonstrative aspects, controller 154 may be configured to control, trigger, cause, and/or instruct a non-AP STA implemented by device 140 to process a first network slicing advertisement from a first AP, e.g., the AP implemented by device 102, for example, to identify a first resource-slice assignment of one or more first radio resource allocations to one or more first QoS network slices supported by the first AP.

In some demonstrative aspects, controller 154 may be configured to control, trigger, cause, and/or instruct a non-AP STA implemented by device 140 to process a second network slicing advertisement from a second AP, for example, to identify a second resource-slice assignment of one or more second radio resource allocations to one or more second QoS network slices supported by the second AP.

In some demonstrative aspects, controller 154 may be configured to control, trigger, cause, and/or instruct a non-AP STA implemented by device 140 to select an AP to associate with, for example, based on the first resource-slice assignment and the second resource-slice assignment.

In some demonstrative aspects, controller 154 may be configured to control, trigger, cause, and/or instruct a non-AP STA implemented by device 140 to select to trigger roaming to an other AP, e.g., different from a current AP with which the non-AP ST Ais currently associated, for example, based on network slicing assignment information from the other AP, which may indicate one or more other QoS network slices supported by the other AP.

In some demonstrative aspects, controller 154 may be configured to control, trigger, cause, and/or instruct a non-AP STA implemented by device 140 to transmit a connection request to the AP, e.g., from which the network slicing advertisement is received.

In some demonstrative aspects, the connection request may be configured to identify a request, e.g., from the AP, to connect the non-AP STA to a requested QoS network slice of the one or more QoS network slices.

In some demonstrative aspects, controller 154 may be configured to control, trigger, cause, and/or instruct a non-AP STA implemented by device 140 to process a connection response from the AP, for example, to identify whether or not the connection request is accepted.

In some demonstrative aspects, controller 154 may be configured to control, trigger, cause, and/or instruct a non-AP STA implemented by device 140 to identify an updated assignment of the one or more radio resource allocations to the one or more QoS network slices, for example, based on updated network slicing assignment information in an updated network slicing advertisement from the AP, e.g., as described below.

In some demonstrative aspects, controller 154 may be configured to control, trigger, cause, and/or instruct a non-AP STA implemented by device 140 to identify that the updated assignment of the one or more radio resource allocations to the one or more QoS network slices includes, for example, an addition of at least one additional QoS network slice to the one or more QoS network slices.

In some demonstrative aspects, controller 154 may be configured to control, trigger, cause, and/or instruct a non-AP STA implemented by device 140 to identify that the updated assignment of the one or more radio resource allocations to the one or more QoS network slices includes, for example, a deletion of at least one deleted QoS network slice from the one or more QoS network slices.

In some demonstrative aspects, controller 154 may be configured to control, trigger, cause, and/or instruct a non-AP STA implemented by device 140 to transmit a QoS network slice request to the AP, e.g., as described below.

In some demonstrative aspects, the QoS network slice request may be configured to identify an additional QoS network slice to be added to the one or more QoS network slices, e.g., as advertised by the AP.

In some demonstrative aspects, controller 154 may be configured to control, trigger, cause, and/or instruct a non-AP STA implemented by device 140 to process a response from the AP, for example, to identify whether the QoS network slice request is accepted or rejected.

In some demonstrative aspects, controller 154 may be configured to control, trigger, cause, and/or instruct a non-AP STA implemented by device 140 to process the response to identify a radio resource allocation for the additional QoS network slice, for example, based on a determination that the QoS network slice request is accepted.

In some demonstrative aspects, controller 154 may be configured to control, trigger, cause, and/or instruct a non-AP STA implemented by device 140 to identify, for example, based on the network slicing assignment information, a pool of radio resources to be used by the particular QoS network slice, for example, when the particular radio resource allocation for the particular QoS network slice is not available.

In some demonstrative aspects, controller 154 may be configured to control, trigger, cause, and/or instruct a non-AP STA implemented by device 140 to identify, for example, based on the network slicing assignment information, that the particular radio resource allocation for the particular QoS network slice includes one or more dedicated radio resources to be dedicated to communication of the traffic of the particular QoS network slice.

In some demonstrative aspects, controller 154 may be configured to control, trigger, cause, and/or instruct a non-AP STA implemented by device 140 to identify, for example, based on the network slicing assignment information, that the particular radio resource allocation for the particular QoS network slice includes one or more prioritized radio resources to prioritize communication of the traffic of the particular QoS network slice.

In some demonstrative aspects, controller 154 may be configured to control, trigger, cause, and/or instruct a non-AP STA implemented by device 140 to identify, for example, based on the network slicing assignment information, that the particular radio resource allocation for the particular QoS network slice includes one or more shared radio resources, which may be shared with one or more other QoS network slices.

In some demonstrative aspects, controller 154 may be configured to control, trigger, cause, and/or instruct a non-AP STA implemented by device 140 to identify, for example, based on the network slicing assignment information, that the one or more radio resource allocations include one or more OFDMA RU allocations, e.g., as described below.

In some demonstrative aspects, the one or more OFDMA RU allocations may include, for example, a first OFDMA RU allocation of one or more first RUs assigned to a first QoS network slice, and a second OFDMA RU allocation of one or more second RUs assigned to a second QoS network slice.

In some demonstrative aspects, controller 154 may be configured to control, trigger, cause, and/or instruct a non-AP STA implemented by device 140 to identify, for example, based on the network slicing assignment information, that the one or more radio resource allocations include one or more link allocations according to an MLO scheme, e.g., as described below.

In some demonstrative aspects, the one or more link allocations may include a first link allocation of a first link assigned to a first QoS network slice, and a second link allocation of a second link assigned to a second QoS network slice.

In some demonstrative aspects, the first link allocation may include, for example, a first link in a first wireless communication frequency band.

In some demonstrative aspects, the second link allocation may include, for example, a second link in a second wireless communication frequency band.

In some demonstrative aspects, the first and second link allocations may be in a same wireless communication frequency band.

In some demonstrative aspects, controller 154 may be configured to control, trigger, cause, and/or instruct a non-AP STA implemented by device 140 to identify, for example, based on the network slicing assignment information, that the particular radio resource allocation for the particular QoS network slice includes a first link and a second link.

In some demonstrative aspects, controller 154 may be configured to control, trigger, cause, and/or instruct a non-AP STA implemented by device 140 to determine that the traffic of the particular QoS network slice is to be assigned for communication over the first link, for example, at a higher priority compared to traffic of one or more other QoS network slices.

In some demonstrative aspects, controller 154 may be configured to control, trigger, cause, and/or instruct a non-AP STA implemented by device 140 to determine that the traffic of the particular QoS network slice is to be assigned for communication over the second link, for example, at a lower priority compared to traffic of another QoS network slice assigned to the second link.

In some demonstrative aspects, controller 154 may be configured to control, trigger, cause, and/or instruct a non-AP STA implemented by device 140 to identify, for example, based on the network slicing assignment information, a default radio resource allocation to communicate traffic not belonging to the one or more QoS network slices.

In some demonstrative aspects, device 102, device 140, and/or device 160 may be configured to implement one or more operations and/or functionalities of a WLAN-based QoS network slicing mechanism, e.g., as described below.

In some demonstrative aspects, the WLAN-based QoS network slicing mechanism may define one or more components and/or operations to support signaling techniques, protocols and/or a framework, for example, to utilize QoS network slicing in Wi-Fi, e.g., as described below.

In some demonstrative aspects, the WLAN-based QoS network slicing mechanism may define one or more components of a framework to utilize QoS network slicing in Wi-Fi, e.g., as described below.

In some demonstrative aspects, it may be defined that network resources are to be sliced into multiple chunks, which may be utilized to perform QoS slicing.

In some demonstrative aspects, it may be defined that a resource chunk, e.g., each resource chunk, is to be assigned to a QoS slice, and may be managed to provide a desired QoS.

In some demonstrative aspects, it may be defined that association with multiple slices, e.g., simultaneously, may be performed, for example, by only one signaling connection.

In some demonstrative aspects, it may be defined that a QoS slice, e.g., each slice, may be assigned with either shared, prioritized, or dedicated radio resources.

In some demonstrative aspects, a resource repartitioning may be implemented, for example, to allow a slice to use resources from a shared pool and/or a prioritized pool, for example, when its own dedicated or prioritized resources are not available.

In some demonstrative aspects, it may be defined that QoS slices may be realized, for example, by scheduling and, potentially, different PHY/MAC configurations.

In some demonstrative aspects, it may be defined that a QoS slice, e.g., each slice, may be uniquely identified, for example, by a network slice ID, a slice type indicator, and/or any other suitable indicator or identifier.

In some demonstrative aspects, it may be defined that both the network and a client device, e.g., a non-AP STA, may be allowed to initiate slice configuration of one or more QoS slices.

In some demonstrative aspects, it may be defined that a device, e.g., a non-AP STA, may be allowed to request to set up a new connection, trigger a QoS slice configuration, and/or send a requested slice ID.

In some demonstrative aspects, it may be defined that the infrastructure and/or the AP may select whether to accept or reject the request, for example, based on a channel condition, application QoS requirements, an available network capacity, and/or any other suitable information and/or criteria.

In some demonstrative aspects, it may be defined that the network may validate if the user has the rights to access a certain slice.

In some demonstrative aspects, it may be defined that the network may initiate slice configuration, and to provide a slice ID.

In some demonstrative aspects, it may be defined that the device is to convey a slice ID, e.g., when triggered by network.

In some demonstrative aspects, it may be defined that QoS differentiation within a QoS slice may be supported, for example, through intra-slice resource allocation.

In some demonstrative aspects, it may be defined that the WLAN-based slicing framework may be extended to support Multi-AP functionality, for example, while considering interference, network congestion, and/or network management, e.g., across multiple APs.

In some demonstrative aspects, the WLAN-based QoS network slicing mechanism may define one or more techniques to implement radio resource management, for example, to support a SLA per slice, and/or to avoid shortage of resources in any slice, e.g., as described below.

In some demonstrative aspects, the WLAN-based QoS network slicing mechanism may define scheduling of radio resources according to an OFDMA scheme, e.g., as described below.

In some demonstrative aspects, it may be defined that a QoS slice, e.g., each slice, is to be allocated a certain portion of a frequency band. In one example, 1/3^{rd} of a frequency band may be allocated to low latency traffic.

In some demonstrative aspects, the allocation of portions of the frequency band to one or more QoS slices may be performed dynamically, for example, based on requirements of applications, channel conditions, network status, or the like.

In some demonstrative aspects, it may be defined that devices and/or applications belonging to a same QoS slice may be subject to a predefined scheduling scheme, e.g., a proportional fair scheduling scheme, for scheduling transmissions.

In some demonstrative aspects, it may be defined that devices and/or applications belonging to a same QoS slice may be allocated with resource units (RUs) from the channel bandwidth (BW) assigned to the QoS slice.

For example, it may be defined that in a downlink (DL) direction, an AP may schedule the applications from the assigned bandwidth.

For example, it may be defined that in an Uplink (UL) direction, a trigger-based mechanism may be used for scheduling applications in each slice.

For example, it may be defined that a minimum RU may be allocated to all applications, e.g., to support legacy devices.

In some demonstrative aspects, the WLAN-based QoS network slicing mechanism may define scheduling of radio resources according to an MLO scheme, e.g., as described below.

In some demonstrative aspects, the WLAN-based QoS network slicing mechanism may define scheduling of multiple links to multiple QoS slices, e.g., as described below.

In some demonstrative aspects, it may be defined that a specific band is to allocated for a QoS slice, e.g., for each slice.

In some demonstrative aspects, a MLO mechanism, e.g., in compliance with an IEEE 802.11be Specification, may be utilized to facilitate device association to one or more QoS slices, e.g., to all slices, and/or to facilitate seamless moving across QoS slices.

In some demonstrative aspects, an MLO device may simultaneously connect to multiple slices, and support different traffics with different SLAs, e.g. Ultra Reliable Low Latency Communications (URLLC) and/or High Throughput (HT).

In some demonstrative aspects, it may be defined that a single radio device, e.g., at an Enhanced Multilink Single-Radio (EMLSR) operation mode, may associate with multiple QoS slices, and may be allowed switch an application, for example, across slices, e.g., according to an MLO orchestration. For example, the single radio device may only be able to connect to one QoS slice at a time.

In some demonstrative aspects, it may be defined that a portion of bandwidth in a link, e.g., any link, may be allocated to legacy devices, for example, to satisfy a minimal SLA.

In some demonstrative aspects, the MLO may be implemented to facilitate association and/or orchestration across the QoS slices.

In some demonstrative aspects, the slicing framework may associate a QoS slice, e.g., each slice, to a primary link, and to one or more secondary links.

In some demonstrative aspects, it may be defined that in the secondary links, the QoS slice may have a lower priority, e.g., with respect to QoS slices that use this link as a primary link.

In some demonstrative aspects, it may be defined that slices that have a low priority on a link may be served in that link based on availability, for example, only if flows that use this link as a primary link do not occupy all the available resources of the link. For example, this definition may provide a technical solution to provide a cross-link slicing mechanism, which may be adaptive to the load of the QoS slices.

In some demonstrative aspects, it may be defined that the network may limit association of certain flows, for example, to only primary links, e.g., with low latency.

In some demonstrative aspects, the primary and secondary links may be defined in a same communication band, or in different bands.

In some demonstrative aspects, primary and secondary links may be defined, for example, for Low latency (LL), High throughput (HT), Best effort (BE) traffic, and/or for legacy devices.

In some demonstrative aspects, the use of the primary and secondary multi-link scheme for QoS slicing may be extended, for example, to include mmWave bands, licensed bands, and/or any other additional or alternative suitable frequency bands, for example, to support multispectral QoS slicing.

In some demonstrative aspects, the WLAN-based QoS network slicing mechanism may define one or more operations and/or protocols to support mobility of a client device, e.g., a non-AP STA, between one or more APs, e.g., as described below.

In some demonstrative aspects, the WLAN-based QoS network slicing mechanism may define one or more operations and/or protocols to support slice-based AP reselection, e.g., as described below.

In some demonstrative aspects, it may be defined that when a device supports slice-based AP reselection, the device may use slice-based AP reselection information.

In some demonstrative aspects, it may be defined that and AP may signal slice capabilities (availability), and may notify the availability of one or multiple link portions, to which the device may connect according to its capabilities.

In some demonstrative aspects, Radio Access Network (RAN) awareness of the QoS slices supported in neighboring APs (Cells) may be utilized by devices for mobility.

In some demonstrative aspects, slice awareness may be reported, for example, before any packet transmission e.g., by indication of Slice-ID.

In some demonstrative aspects, for example, during the initial context setup, the RAN may be informed of the slice for which resources are being requested.

In some demonstrative aspects, slice-ID may be introduced as part of the mobility signaling, for example, to provide a technical solution to support slice-aware mobility. For example, this implementation may support slice-aware admission and/or congestion control.

In some demonstrative aspects, it may be defined that handovers of a device between APs may be allowed, for example, regardless of the QoS slice support of a target AP. For example, it may be defined, that a non-AP device may be handed over from a source AP to a target AP, for example, even if the target AP does not support the same QoS slices as the source AP.

In some demonstrative aspects, the WLAN-based QoS network slicing mechanism may define one or more operations and/or protocols to support aggregation of sub-10 GHz networks, e.g., WiFi networks, with mmWave networks, for example, 60 Ghz networks, e.g., as described below.

In some demonstrative aspects, the WLAN-based QoS slicing framework may be utilized to aggregate Wi-Fi and 60 GHz networks.

In some demonstrative aspects, multi-link operation may be utilized to dynamically dispatch packets to a plurality of different wireless communication bands, for example, according to a criterion to maximize the utilization of resources available in each band, for example, without penalizing the performance requirements of each QoS slice.

In some demonstrative aspects, QoS slices that require high reliability may be allocated, for example, in lower portions of the spectrum, which may benefit from reduced pathloss. For example, protocols to allocate applications to specific slices may be implementation specific.

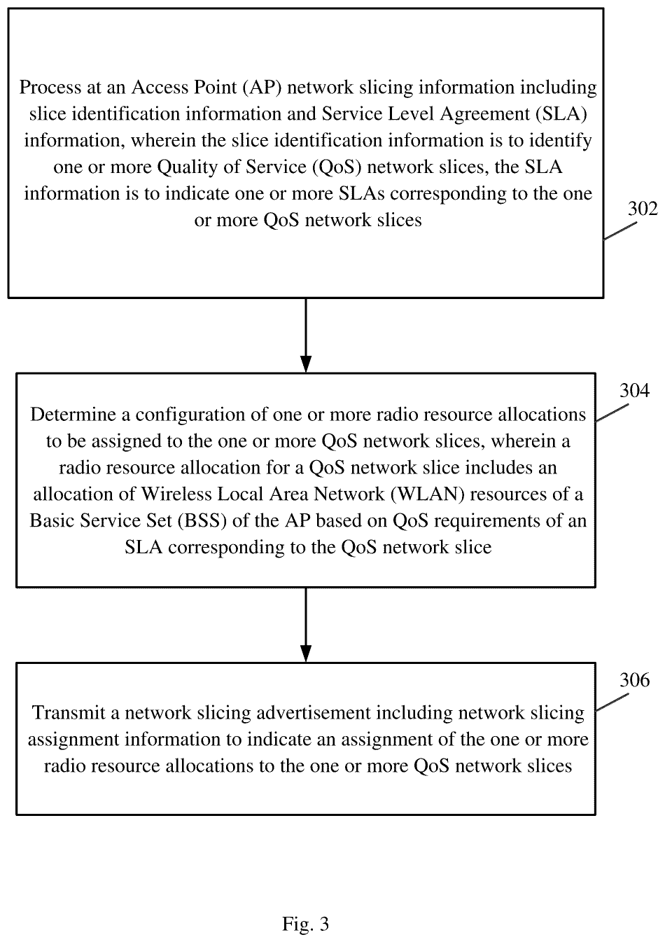

Reference is made to FIG. 3, which schematically illustrates a method of QoS network slicing over WLAN, in accordance with some demonstrative aspects. For example, one or more of the operations of the method of FIG. 3 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 302, the method may include processing at an AP network slicing information including slice identification information and SLA information. For example, the slice identification information may identify one or more QoS network slices. For example, the SLA information may indicate one or more SLAs corresponding to the one or more QoS network slices. For example, controller 124 (FIG. 1) may be configured to control, trigger, cause, and/or instruct the AP implemented by device 102 (FIG. 1) to process the network slicing information including the slice identification information and the SLA information, e.g., as described above.

As indicated at block 304, the method may include determining a configuration of one or more radio resource allocations to be assigned to the one or more QoS network slices. For example, a radio resource allocation for a QoS network slice may include an allocation of WLAN resources of a BSS of the AP, for example, based on QoS requirements of an SLA corresponding to the QoS network slice. For example, controller 124 (FIG. 1) may be configured to control, trigger, cause, and/or instruct the AP implemented by device 102 (FIG. 1) to determine the configuration of one or more radio resource allocations to be assigned to the one or more QoS network slices, e.g., as described above.

As indicated at block 306, the method may include transmitting from the AP a network slicing advertisement including network slicing assignment information to indicate an assignment of the one or more radio resource allocations to the one or more QoS network slices. For example, controller 124 (FIG. 1) may be configured to control, trigger, cause, and/or instruct the AP implemented by device 102 (FIG. 1) to transmit the network slicing advertisement, e.g., as described above.

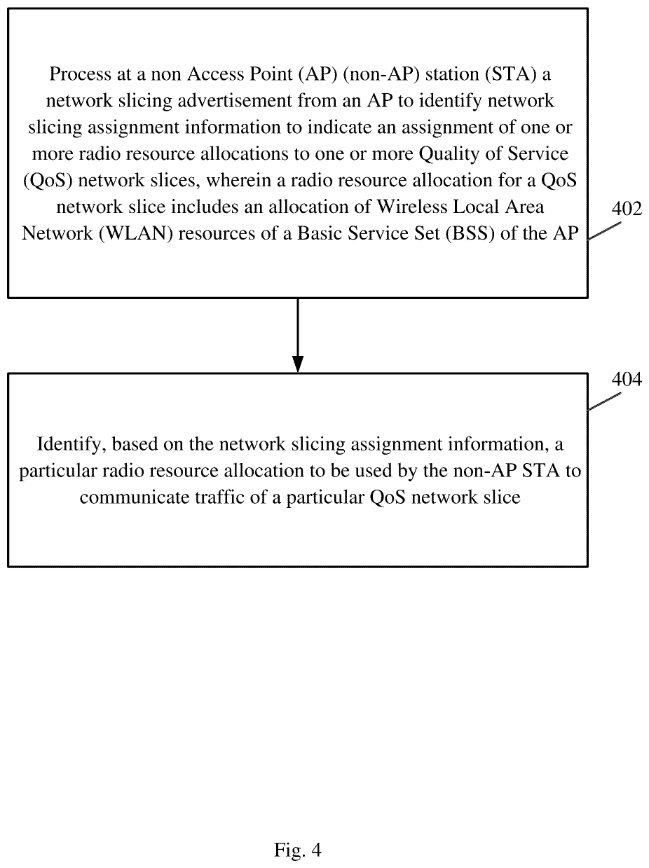

Reference is made to FIG. 4, which schematically illustrates a method of QoS network slicing over WLAN, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include processing at a non-AP STA a network slicing advertisement from an AP to identify network slicing assignment information to indicate an assignment of one or more radio resource allocations to one or more QoS network slices. For example, a radio resource allocation for a QoS network slice may include an allocation of WLAN resources of a BSS of the AP. For example, controller 154 (FIG. 1) may be configured to control, trigger, cause, and/or instruct the STA implemented by device 140 (FIG. 1) to process the network slicing advertisement from the AP to identify the network slicing assignment information to indicate the assignment of one or more radio resource allocations to one or more QoS network slices, e.g., as described above.

As indicated at block 404, the method may include identifying, based on the network slicing assignment information, a particular radio resource allocation to be used by the non-AP STA to communicate traffic of a particular QoS network slice. For example, controller 154 (FIG. 1) may be configured to identify the particular radio resource allocation to be used by the non-AP STA to communicate traffic of the particular QoS network slice, for example, based on the network slicing assignment information, e.g., as described above.

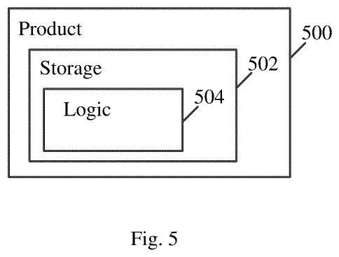

Reference is made to FIG. 5, which schematically illustrates a product of manufacture 500, in accordance with some demonstrative aspects. Product 500 may include one or more tangible computer-readable (“machine-readable”) non-transitory storage media 502, which may include computer-executable instructions, e.g., implemented by logic 504, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-4, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 500 and/or machine readable storage media 502 may include one or more types of computer-readable storage media capable of storing data, including volatile memory, non-volatile memory, removable or non-removable memory, erasable or non-erasable memory, writeable or re-writeable memory, and the like. For example, machine readable storage media 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause an Access Point (AP) to process network slicing information comprising slice identification information and Service Level Agreement (SLA) information, wherein the slice identification information is to identify one or more Quality of Service (QoS) network slices, the SLA information is to indicate one or more SLAs corresponding to the one or more QoS network slices; determine a configuration of one or more radio resource allocations to be assigned to the one or more QoS network slices, wherein a radio resource allocation for a QoS network slice comprises an allocation of Wireless Local Area Network (WLAN) resources of a Basic Service Set (BSS) of the AP based on QoS requirements of an SLA corresponding to the QoS network slice; and transmit a network slicing advertisement comprising network slicing assignment information to indicate an assignment of the one or more radio resource allocations to the one or more QoS network slices.

Example 2 includes the subject matter of Example 1, and optionally, wherein the apparatus is configured to cause the AP to configure a first radio resource allocation for a first QoS network slice based on first QoS requirements of a first SLA corresponding to the first QoS network slice, and to configure a second radio resource allocation for a second QoS network slice based on second QoS requirements of a second SLA corresponding to the second QoS network slice, wherein the second radio resource allocation is different from the first radio resource allocation, wherein the second QoS requirements of the second SLA are different from the first QoS requirements of the first SLA.

Example 3 includes the subject matter of Example 1 or 2, and optionally, wherein the apparatus is configured to cause the AP to determine an updated assignment of the one or more radio resource allocations to the one or more QoS network slices based on a change in the one or more QoS network slices, and to transmit an updated network slicing advertisement comprising updated network slicing assignment information to indicate the updated assignment of the one or more radio resource allocations to the one or more QoS network slices.

Example 4 includes the subject matter of Example 3, and optionally, wherein the change in the one or more QoS network slices comprises an addition of at least one additional QoS network slice to the one or more QoS network slices.

Example 5 includes the subject matter of Example 3 or 4, and optionally, wherein the change in the one or more QoS network slices comprises a deletion of at least one deleted QoS network slice from the one or more QoS network slices.

Example 6 includes the subject matter of any one of Examples 3-5, and optionally, wherein the change in the one or more QoS network slices comprises a change in at least one updated QoS network slice of the one or more QoS network slices based on a change in an SLA of the updated QoS network slice.

Example 7 includes the subject matter of any one of Examples 1-6, and optionally, wherein the apparatus is configured to cause the AP to determine an updated assignment of the one or more radio resource allocations to the one or more QoS network slices based on at least one of a utilization level of the one or more QoS network slices, or traffic demands to communicate traffic with one or more non-AP STAs over the one or more QoS network slices.

Example 8 includes the subject matter of any one of Examples 1-7, and optionally, wherein the apparatus is configured to cause the AP to process a connection request from a non-AP STA in the BSS of the AP, the connection request to identify a request to connect the non-AP STA to a requested QoS network slice of the one or more QoS network slices; and transmit to the non-AP STA a connection response configured to indicate whether or not the connection request is accepted.

Example 9 includes the subject matter of any one of Examples 1-8, and optionally, wherein the apparatus is configured to cause the AP to process a QoS network slice request from a non-AP STA in the BSS of the AP, the QoS network slice request to identify an additional QoS network slice to be added to the one or more QoS network slices; select whether to accept or reject the QoS network slice request; and based on a determination that the QoS network slice request is to be accepted, configure a radio resource allocation for the additional QoS network slice based on QoS requirements of an SLA corresponding to the additional QoS network slice.

Example 10 includes the subject matter of any one of Examples 1-9, and optionally, wherein the apparatus is configured to cause the AP to configure a pool of radio resources to be used by the QoS network slice when the radio resource allocation for the QoS network slice is not available.

Example 11 includes the subject matter of any one of Examples 1-10, and optionally, wherein the apparatus is configured to cause the AP to configure the radio resource allocation for the QoS network slice to comprise one or more dedicated radio resources to be dedicated to communication of traffic of the QoS network slice.

Example 12 includes the subject matter of any one of Examples 1-11, and optionally, wherein the apparatus is configured to cause the AP to configure the radio resource allocation for the QoS network slice to comprise one or more prioritized radio resources to prioritize communication of traffic of the QoS network slice.

Example 13 includes the subject matter of any one of Examples 1-12, and optionally, wherein the apparatus is configured to cause the AP to configure the radio resource allocation for the QoS network slice to comprise one or more shared radio resources to be shared with one or more other QoS network slices.

Example 14 includes the subject matter of any one of Examples 1-13, and optionally, wherein the one or more radio resource allocations comprises one or more Orthogonal Frequency-Division Multiple Access (OFDMA) Resource Unit (RU) allocations.

Example 15 includes the subject matter of Example 14, and optionally, wherein the one or more OFDMA RU allocations comprises a first OFDMA RU allocation of one or more first RUs assigned to a first QoS network slice, and a second OFDMA RU allocation of one or more second RUs assigned to a second QoS network slice.

Example 16 includes the subject matter of any one of Examples 1-15, and optionally, wherein the one or more radio resource allocations comprises one or more link allocations according to a Multi-Link Operation (MLO) scheme.

Example 17 includes the subject matter of Example 16, and optionally, wherein the one or more link allocations comprises a first link allocation of a first link assigned to a first QoS network slice, and a second link allocation of a second link assigned to a second QoS network slice.

Example 18 includes the subject matter of Example 17, and optionally, wherein the first link allocation comprises a first link in a first wireless communication frequency band, and the second link allocation comprises a second link in a second wireless communication frequency band.

Example 19 includes the subject matter of Example 17, and optionally, wherein the first and second link allocations are in a same wireless communication frequency band.

Example 20 includes the subject matter of any one of Examples 16-19, and optionally, wherein the radio resource allocation for the QoS network slice comprises a first link and a second link, wherein traffic of the QoS network slice is to be assigned for communication over the first link at a higher priority compared to traffic of one or more other QoS network slices, wherein the traffic of the QoS network slice is to be assigned for communication over the second link at a lower priority compared to traffic of another QoS network slice assigned to the second link.

Example 21 includes the subject matter of any one of Examples 1-20, and optionally, wherein the apparatus is configured to cause the AP to configure the radio resource allocation to be assigned to the QoS network slice based on at least one of a throughput requirement of the SLA corresponding to the QoS network slice, a latency requirement of the SLA corresponding to the QoS network slice, or a reliability requirement of the SLA corresponding to the QoS network slice.

Example 22 includes the subject matter of any one of Examples 1-21, and optionally, wherein the apparatus is configured to cause the AP to configure one or more QoS characteristics of the radio resource allocation for the QoS network slice based on at least one of a throughput requirement of the SLA corresponding to the QoS network slice, a latency requirement of the SLA corresponding to the QoS network slice, or a reliability requirement of the SLA corresponding to the QoS network slice.

Example 23 includes the subject matter of any one of Examples 1-22, and optionally, wherein the apparatus is configured to cause the AP to configure the radio resource allocation for the QoS network slice to guarantee the QoS requirements of the SLA corresponding to the QoS network slice.

Example 24 includes the subject matter of any one of Examples 1-23, and optionally, wherein the apparatus is configured to cause the AP to configure the one or more radio resource allocations to comprise a default radio resource allocation to communicate traffic not belonging to the one or more QoS network slices.

Example 25 includes the subject matter of any one of Examples 1-24, and optionally, wherein the network slicing advertisement comprises the slice identification information to identify the one or more QoS network slices.

Example 26 includes the subject matter of any one of Examples 1-25, and optionally, wherein the slice identification information comprises at least one of a slice Identifier (ID) to identify the QoS network slice, or a slice type indicator to identify the QoS network slice.

Example 27 includes the subject matter of any one of Examples 1-26, and optionally, wherein the apparatus is configured to cause the AP to configure a plurality of WLAN resource allocations for a respective plurality of simultaneously operative QoS network slices.

Example 28 includes the subject matter of any one of Examples 1-27, and optionally, wherein the network slicing information is from a network slicing manager.

Example 29 includes the subject matter of any one of Examples 1-28, and optionally, wherein the apparatus is configured to cause the AP to transmit the network slicing advertisement in at least one of a beacon frame, or a neighbor report element.

Example 30 includes the subject matter of any one of Examples 1-29, and optionally, comprising at least one radio to transmit the network slicing advertisement from the AP.

Example 31 includes the subject matter of Example 30, and optionally, comprising one or more antennas connected to the radio, and a processor to execute instructions of an operating system.

Example 32 includes an apparatus comprising logic and circuitry configured to cause a non Access Point (AP) (non-AP) station (STA) to process a network slicing advertisement from an AP to identify network slicing assignment information to indicate an assignment of one or more radio resource allocations to one or more Quality of Service (QoS) network slices, wherein a radio resource allocation for a QoS network slice comprises an allocation of Wireless Local Area Network (WLAN) resources of a Basic Service Set (BSS) of the AP; and identify, based on the network slicing assignment information, a particular radio resource allocation to be used by the non-AP STA to communicate traffic of a particular QoS network slice.

Example 33 includes the subject matter of Example 32, and optionally, wherein the apparatus is configured to cause the non-AP STA to determine, based on the network slicing assignment information, whether or not to associate with the AP.

Example 34 includes the subject matter of Example 32 or 33, and optionally, wherein the apparatus is configured to cause the non-AP STA to process a first network slicing advertisement from a first AP to identify a first resource-slice assignment of one or more first radio resource allocations to one or more first QoS network slices supported by the first AP, process a second network slicing advertisement from a second AP to identify a second resource-slice assignment of one or more second radio resource allocations to one or more second QoS network slices supported by the second AP, and to select an AP to associate with based on the first resource-slice assignment and the second resource-slice assignment.

Example 35 includes the subject matter of any one of Examples 32-34, and optionally, wherein the apparatus is configured to cause the non-AP STA to select to trigger roaming to an other AP based on network slicing assignment information from the other AP to indicate one or more other QoS network slices supported by the other AP.

Example 36 includes the subject matter of any one of Examples 32-35, and optionally, wherein the apparatus is configured to cause the non-AP STA to transmit a connection request to the AP, the connection request to identify a request to connect the non-AP STA to a requested QoS network slice of the one or more QoS network slices; and process a connection response from the AP to identify whether or not the connection request is accepted.

Example 37 includes the subject matter of any one of Examples 32-36, and optionally, wherein the apparatus is configured to cause the non-AP STA to identify an updated assignment of the one or more radio resource allocations to the one or more QoS network slices based on updated network slicing assignment information in an updated network slicing advertisement from the AP.

Example 38 includes the subject matter of Example 37, and optionally, wherein the updated assignment of the one or more radio resource allocations to the one or more QoS network slices comprises an addition of at least one additional QoS network slice to the one or more QoS network slices.

Example 39 includes the subject matter of Example 37 or 38, and optionally, wherein the updated assignment of the one or more radio resource allocations to the one or more QoS network slices comprises a deletion of at least one deleted QoS network slice from the one or more QoS network slices.

Example 40 includes the subject matter of any one of Examples 32-39, and optionally, wherein the apparatus is configured to cause the non-AP STA to transmit a QoS network slice request to the AP, the QoS network slice request to identify an additional QoS network slice to be added to the one or more QoS network slices; and process a response from the AP to identify whether the QoS network slice request is accepted or rejected.

Example 41 includes the subject matter of Example 40, and optionally, wherein the apparatus is configured to cause the non-AP STA to, based on a determination that the QoS network slice request is accepted, process the response to identify a radio resource allocation for the additional QoS network slice.

Example 42 includes the subject matter of any one of Examples 32-41, and optionally, wherein the apparatus is configured to cause the non-AP STA to identify, based on the network slicing assignment information, a pool of radio resources to be used by the particular QoS network slice when the particular radio resource allocation for the particular QoS network slice is not available.

Example 43 includes the subject matter of any one of Examples 32-42, and optionally, wherein the apparatus is configured to cause the non-AP STA to identify, based on the network slicing assignment information, that the particular radio resource allocation for the particular QoS network slice comprises one or more dedicated radio resources to be dedicated to communication of the traffic of the particular QoS network slice.

Example 44 includes the subject matter of any one of Examples 32-43, and optionally, wherein the apparatus is configured to cause the non-AP STA to identify, based on the network slicing assignment information, that the particular radio resource allocation for the particular QoS network slice comprises one or more prioritized radio resources to prioritize communication of the traffic of the particular QoS network slice.

Example 45 includes the subject matter of any one of Examples 32-44, and optionally, wherein the apparatus is configured to cause the non-AP STA to identify, based on the network slicing assignment information, that the particular radio resource allocation for the particular QoS network slice comprises one or more shared radio resources to be shared with one or more other QoS network slices.

Example 46 includes the subject matter of any one of Examples 32-45, and optionally, wherein the one or more radio resource allocations comprises one or more Orthogonal Frequency-Division Multiple Access (OFDMA) Resource Unit (RU) allocations.

Example 47 includes the subject matter of Example 46, and optionally, wherein the one or more OFDMA RU allocations comprises a first OFDMA RU allocation of one or more first RUs assigned to a first QoS network slice, and a second OFDMA RU allocation of one or more second RUs assigned to a second QoS network slice.

Example 48 includes the subject matter of any one of Examples 32-47, and optionally, wherein the one or more radio resource allocations comprises one or more link allocations according to a Multi-Link Operation (MLO) scheme.

Example 49 includes the subject matter of Example 48, and optionally, wherein the one or more link allocations comprises a first link allocation of a first link assigned to a first QoS network slice, and a second link allocation of a second link assigned to a second QoS network slice.

Example 50 includes the subject matter of Example 49, and optionally, wherein the first link allocation comprises a first link in a first wireless communication frequency band, and the second link allocation comprises a second link in a second wireless communication frequency band.

Example 51 includes the subject matter of Example 49, and optionally, wherein the first and second link allocations are in a same wireless communication frequency band.

Example 52 includes the subject matter of any one of Examples 49-50, and optionally, wherein the apparatus is configured to cause the non-AP STA to identify, based on the network slicing assignment information, that the particular radio resource allocation for the particular QoS network slice comprises a first link and a second link, and to determine that the traffic of the particular QoS network slice is to be assigned for communication over the first link at a higher priority compared to traffic of one or more other QoS network slices, and that the traffic of the particular QoS network slice is to be assigned for communication over the second link at a lower priority compared to traffic of another QoS network slice assigned to the second link.

Example 53 includes the subject matter of any one of Examples 32-52, and optionally, wherein the apparatus is configured to cause the non-AP STA to identify, based on the network slicing assignment information, a default radio resource allocation to communicate traffic not belonging to the one or more QoS network slices.

Example 54 includes the subject matter of any one of Examples 32-53, and optionally, wherein the network slicing advertisement comprises slice identification information to identify the one or more QoS network slices.

Example 55 includes the subject matter of Example 54, and optionally, wherein the slice identification information comprises at least one of a slice Identifier (ID) to identify the QoS network slice, or a slice type indicator to identify the QoS network slice.

Example 56 includes the subject matter of any one of Examples 32-55, and optionally, wherein the apparatus is configured to cause the non-AP STA to identify the network slicing advertisement in at least one of a beacon frame or a neighbor report element from the AP.

Example 57 includes the subject matter of any one of Examples 32-56, and optionally, comprising at least one radio to receive the network slicing advertisement from the AP.

Example 58 includes the subject matter of Example 57, and optionally, comprising one or more antennas connected to the radio, and a processor to execute instructions of an operating system.

Example 59 comprises a wireless communication device comprising the apparatus of any of Examples 1-58.

Example 60 comprises a mobile device comprising the apparatus of any of Examples 1-58.

Example 61 comprises an apparatus comprising means for executing any of the described operations of any of Examples 1-58.

Example 62 comprises a product comprising one or more tangible computer-readable non-transitory storage media comprising instructions operable to, when executed by at least one processor, enable the at least one processor to cause a wireless communication device to perform any of the described operations of any of Examples 1-58.

Example 63 comprises an apparatus comprising: a memory interface; and processing circuitry configured to: perform any of the described operations of any of Examples 1-58.

Example 64 comprises a method comprising any of the described operations of any of Examples 1-58.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause an Access Point (AP) to:
process network slicing information comprising slice identification information and Service Level Agreement (SLA) information, wherein the slice identification information is to identify one or more Quality of Service (QoS) network slices, the SLA information is to indicate one or more SLAs corresponding to the one or more QoS network slices;
determine a configuration of one or more radio resource allocations to be assigned to the one or more QoS network slices, wherein a radio resource allocation for a QoS network slice comprises an allocation of Wireless Local Area Network (WLAN) resources of a Basic Service Set (BSS) of the AP based on QoS requirements of an SLA corresponding to the QoS network slice; and
transmit a network slicing advertisement comprising network slicing assignment information to indicate an assignment of the one or more radio resource allocations to the one or more QoS network slices.

2. The apparatus of claim 1 configured to cause the AP to configure a first radio resource allocation for a first QoS network slice based on first QoS requirements of a first SLA corresponding to the first QoS network slice, and to configure a second radio resource allocation for a second QoS network slice based on second QoS requirements of a second SLA corresponding to the second QoS network slice, wherein the second radio resource allocation is different from the first radio resource allocation, wherein the second QoS requirements of the second SLA are different from the first QoS requirements of the first SLA.

3. The apparatus of claim 1 configured to cause the AP to determine an updated assignment of the one or more radio resource allocations to the one or more QoS network slices based on a change in the one or more QoS network slices, and to transmit an updated network slicing advertisement comprising updated network slicing assignment information to indicate the updated assignment of the one or more radio resource allocations to the one or more QoS network slices.

4. The apparatus of claim 1 configured to cause the AP to:
process a connection request from a non-AP STA in the BSS of the AP, the connection request to identify a request to connect the non-AP STA to a requested QoS network slice of the one or more QoS network slices; and
transmit to the non-AP STA a connection response configured to indicate whether or not the connection request is accepted.

5. The apparatus of claim 1 configured to cause the AP to:
process a QoS network slice request from a non-AP STA in the BSS of the AP, the QoS network slice request to identify an additional QoS network slice to be added to the one or more QoS network slices;
select whether to accept or reject the QoS network slice request; and
based on a determination that the QoS network slice request is to be accepted, configure a radio resource allocation for the additional QoS network slice based on QoS requirements of an SLA corresponding to the additional QoS network slice.

6. The apparatus of claim 1 configured to cause the AP to configure a pool of radio resources to be used by the QoS network slice when the radio resource allocation for the QoS network slice is not available.

7. The apparatus of claim 1 configured to cause the AP to configure the radio resource allocation for the QoS network slice to comprise one or more dedicated radio resources to be dedicated to communication of traffic of the QoS network slice.

8. The apparatus of claim 1 configured to cause the AP to configure the radio resource allocation for the QoS network slice to comprise one or more prioritized radio resources to prioritize communication of traffic of the QoS network slice.

9. The apparatus of claim 1 configured to cause the AP to configure the radio resource allocation for the QoS network slice to comprise one or more shared radio resources to be shared with one or more other QoS network slices.

10. The apparatus of claim 1, wherein the one or more radio resource allocations comprises one or more Orthogonal Frequency-Division Multiple Access (OFDMA) Resource Unit (RU) allocations.

11. The apparatus of claim 10, wherein the one or more OFDMA RU allocations comprises a first OFDMA RU allocation of one or more first RUs assigned to a first QoS network slice, and a second OFDMA RU allocation of one or more second RUs assigned to a second QoS network slice.

12. The apparatus of claim 1, wherein the one or more radio resource allocations comprises one or more link allocations according to a Multi-Link Operation (MLO) scheme.

13. The apparatus of claim 12, wherein the one or more link allocations comprises a first link allocation of a first link assigned to a first QoS network slice, and a second link allocation of a second link assigned to a second QoS network slice.

14. The apparatus of claim 12, wherein the radio resource allocation for the QoS network slice comprises a first link and a second link, wherein traffic of the QoS network slice is to be assigned for communication over the first link at a higher priority compared to traffic of one or more other QoS network slices, wherein the traffic of the QoS network slice is to be assigned for communication over the second link at a lower priority compared to traffic of another QoS network slice assigned to the second link.

15. The apparatus of claim 1 configured to cause the AP to configure the radio resource allocation to be assigned to the QoS network slice based on at least one of a throughput requirement of the SLA corresponding to the QoS network slice, a latency requirement of the SLA corresponding to the QoS network slice, or a reliability requirement of the SLA corresponding to the QoS network slice.

16. The apparatus of claim 1 configured to cause the AP to configure the radio resource allocation for the QoS network slice to guarantee the QoS requirements of the SLA corresponding to the QoS network slice.

17. The apparatus of claim 1 comprising at least one radio to transmit the network slicing advertisement from the AP.

18. The apparatus of claim 17 comprising one or more antennas connected to the radio, and a processor to execute instructions of an operating system.

19. A product comprising one or more tangible computer-readable non-transitory storage media comprising instructions operable to, when executed by at least one processor, enable the at least one processor to cause an Access Point (AP) to:
process network slicing information comprising slice identification information and Service Level Agreement (SLA) information, wherein the slice identification information is to identify one or more Quality of Service (QoS) network slices, the SLA information is to indicate one or more SLAs corresponding to the one or more QoS network slices;
determine a configuration of one or more radio resource allocations to be assigned to the one or more QoS network slices, wherein a radio resource allocation for a QoS network slice comprises an allocation of Wireless Local Area Network (WLAN) resources of a Basic Service Set (BSS) of the AP based on QoS requirements of an SLA corresponding to the QoS network slice; and
transmit a network slicing advertisement comprising network slicing assignment information to indicate an assignment of the one or more radio resource allocations to the one or more QoS network slices.

20. The product of claim 19, wherein the instructions, when executed, cause the AP to:
process a connection request from a non-AP STA in the BSS of the AP, the connection request to identify a request to connect the non-AP STA to a requested QoS network slice of the one or more QoS network slices; and
transmit to the non-AP STA a connection response configured to indicate whether or not the connection request is accepted.
